(19) United States
(12) Patent Application Publication
(10) Pub. No.: US 2017/0372564 A1
(43) Pub. Date: Dec. 28, 2017

(54) Enhanced Wireless Communications and Power Systems for a Venue

(71) Applicants: Paul Amelio, New York, NY (US); Alfonso Amelio, New York, NY (US)

(72) Inventors: Paul Amelio, New York, NY (US); Alfonso Amelio, New York, NY (US)

(21) Appl. No.: 15/633,022

(22) Filed: Jun. 26, 2017

Related U.S. Application Data
(60) Provisional application No. 62/354,359, filed on Jun. 24, 2016.
(60) Provisional application No. 62/354,353, filed on Jun. 24, 2016.

(51) Int. Cl. G08B 5/22; H04W 4/04; H04W 4/00; G06Q 10/06; H04M 1/725; H04L 29/08; H04W 76/02; H04W 4/02

(52) U.S. Cl. CPC G08B 5/223; H04W 76/023; H04W 4/04; H04W 4/021; G06Q 10/06; H04M 1/72519; H04L 67/04; H04W 4/001

(57) ABSTRACT

Systems for providing enhanced wireless communications and power at venues are provided. In one embodiment, the system includes a first communication device that receives audio from a user (such as a coach on a sideline), generates a wireless signal, and transmits the wireless signal to a second communication device via an antenna system (e.g., an antenna system mounted on an overhead camera) that relays the signal. The second communication device (which could be worn by a player during a sporting event) receives the wireless signal and plays the audio. In another embodiment, the wireless signal is broadcast to a plurality of communications devices worn by players. Also provided is a power and communication system for use at a seat at the venue, which provides power for a user's mobile device as well as wired and wireless network (e.g., Internet) connectivity at the seat.

### RELATED APPLICATIONS

This application claims priority to U.S. Provisional Patent Application Ser. No. 62/354,359 filed on Jun. 24, 2016 and U.S. Provisional Patent Application Ser. No. 62/354,353 filed on Jun. 24, 2016, the entire disclosures of which are hereby incorporated by reference.

### BACKGROUND

### Field of the Disclosure

The present disclosure relates to enhancing communications and power systems in a venue. More particularly, the present disclosure relates to enhanced wireless communications and power systems for a venue.

### Related Art

Venues which host athletic events typically do not have adequate communications systems. The lack of proper infrastructure in such venues causes problems where lines of communication are critical.

For example, in an athletic event, it is desirable for coaches to have open lines of communication with players throughout an athletic event. In some sports, it is very difficult for coaches to quickly communicate with players. For example, in an American football game, coaches must remain on the sideline of a football field while communicating a play to the quarterback. In football games where many fans are in attendance, the stadium can be extremely loud which makes it difficult for the coach to verbally communicate a play to a quarterback. Moreover, a football coach must remain on the sideline which can be too far to verbally communicate a play to a quarterback. Still further, there is typically only forty seconds between plays, which makes it undesirable for a quarterback to travel to the sideline to verbally receive the next play. Communicating plays to a quarterback with hand signals can also be undesirable as the other team can intercept such signals and anticipate the next play.

In another example, communication and power systems for the fans themselves are inadequate at sporting venues. For example, when fans attend a sporting event at a stadium, their cell phones have poor cellular reception, restricting use of their mobile devices to access the internet. This is caused by the major infrastructure challenges in a stadium. For example, stadiums are constructed of mostly concrete and steel, and the people sitting in the stadium are made up mostly of fluids which all inhibit proper cellular transmission. Still further, fans want to use the network at the same time, such as during kickoff, halftime, or after a significant scoring play. These issues restrict fans from interacting with social media applications, checking fantasy scores, watching videos, browsing the web, etc. Stadium management and owners want fans to engage in such activities as it enhances and promotes the sporting event. In particular, the cellular service at sporting stadiums precludes the ability to upload a four to five megabyte selfie image. Moreover, limited cellular reception prevents stadium management from taking advantage of commercial opportunities by sending promotional material to fans. Still further, attendees at sporting events often need to recharge their cellular devices, and there are often insufficient power systems at venues for this purpose.

Therefore, there exists a need for enhanced wireless communications and power systems for use at a venue (e.g., in a stadium) which address the foregoing limitations.

### SUMMARY

Systems for providing enhanced wireless communications and power at venues are provided. In one embodiment, the system includes a first communication device that receives audio from a user (such as a coach on a sideline), generates a wireless signal, and transmits the wireless signal to a second communication device via an antenna system (e.g., an antenna system mounted on an overhead camera) that relays the signal. The second communication device (which could be worn by a player during a sporting event) receives the wireless signal and plays the audio. In another embodiment, the wireless signal is broadcast to a plurality of communications devices worn by players. Also provided is a power and communication system for use at a seat at the venue, which provides power for a user's mobile device as well as wired and wireless network (e.g., Internet) connectivity at the seat.

### BRIEF DESCRIPTION OF THE DRAWINGS

The foregoing features of the disclosure will be apparent from the following Detailed Description, taken in connection with the accompanying drawings, in which:

FIG. 1 is a diagram illustrating a first embodiment of the enhanced wireless communications system of the present disclosure;

FIG. 2 is a diagram illustrating a second embodiment of the enhanced wireless communications system the present disclosure;

FIG. 3 is a diagram illustrating a power and communications system for a venue seat;

FIG. 4 is a perspective view of the power and communications system of the present disclosure;

FIG. 5 is a top-down view of a venue illustrating installation of the power and communications system of FIGS. 3-4;

FIG. 6 is a block diagram of a communication link between the power and communications system of FIGS. 3-5 and a plurality of mobile devices held by people in the venue; and

FIG. 7 is a diagram of a communication link to provide enhanced wireless/cellular coverage.

### DETAILED DESCRIPTION

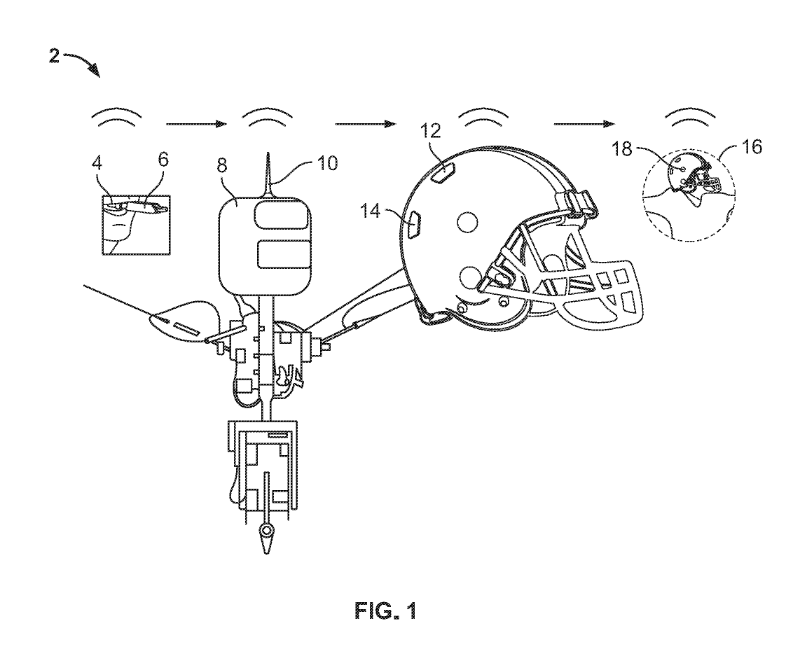

The present disclosure relates to enhanced wireless communications and power systems for use in a venue, as discussed in detail below in connection with FIGS. 1-7.

The present disclosure is generally applicable to any venue or event. The present disclosure by way of example discusses American football, but the present disclosure is not limited to this application and can include any sporting event (soccer, basketball, hockey, wrestling, lacrosse, track and field, racing, archery, darts, video gaming, curling, etc.), concerts, theatre, Broadway plays, musicals, operas, lecture halls, conference rooms, hotels, etc.

FIG. 1 is a diagram illustrating an embodiment of a communication system 2 of the present disclosure, which allows for enhanced wireless communications between coaches and players of a sporting event (e.g., American football). The system 2 can include a first communication device 6 (worn, for example, by a coach 4 on a sideline of a sporting event) for receiving spoken/verbal commands (audio) from coaches or other players at a sporting event, generating a wireless signal including the audio, and transmitting the wireless signal. The system 2 can also include an overhead cable-controlled camera 8 having an antenna extender 10 for relaying wireless signals. The camera 8 can be a computer-controlled, cable-suspended camera system which can operate by having four motorized winches positioned at the corners of a venue. Each of the winches can control a cable connected to the camera 8. A computer system can wind and unwind the cables to allow the camera 8 to reach any position in a three-dimensional space within the venue or field of play. The system 2 can further include a helmet 12 which can be worn by any player on the field. The helmet 12 can include a frequency extender 14. Finally, the system 2 includes a second communication device 18 worn by a player, for receiving the wireless signal from the headset transmitter 6 and playing the audio (spoken commands, instructions, etc.) from the coach 4 to the player 16. The device 18 can be a headset, earpiece or a similar device for receiving a wireless/radio audio signal. In an American football game, the receiving player 16 can be a quarterback responsible for communicating a play for the offensive team. Accordingly, the device 18 can be installed in a helmet that the player 16 is wearing. For other applications, the device 18 can be installed in any suitable equipment that the player 16 may be wearing. It is noted that the second communication device 18 could also receive audio (spoken voice) from the player 16, and wirelessly transmit same to the coach 4 (via the antenna 10) so that the player 16 can communicate with the coach 4, thereby providing bidirectional communications between the player and the coach.

The system 2 can allow the coach 4 to reliably and clearly communicate with the player 16. When the coach 4 speaks into the first communications device 6, a wireless communication signal can be generated and sent to the player 16 via the device 18. The wireless communication signal can be extended by the antenna extender 10 placed on the camera 8. It is noted that the antenna extender 10 is optional, and communications could take place directly between the first communications device 6 and the second communications device 16. As the camera 8 traverses the playing field to capture sporting event moments, the antenna extender 10 can be in a suitable position to extend the wireless communication signal from the coach 4 to the player 16. Furthermore, the wireless communication signal can be further extended by the extended 14 installed in the helmet 12. The helmet 12 can be worn by any player on the field for extended the wireless transmission signal to the receiving player 16. For other applications, the helmet 12 can be any other suitable piece of equipment for housing or having the extender 14. The system 2 can optionally dispense with the helmet 12 and extender 14 and rely solely on the camera 8 and antenna extender 10 for communication between the coach 4 and the player 16. Moreover, the system 2 can optionally dispense with the camera 8 and antenna extended 10 and rely solely on the helmet 12 and extender 14 for communication between the coach 4 and the player 16. Still further the system 2 can rely on a plurality of helmets 12 for communication between the coach 4 and the player 16. For example, a wide receiver could have the helmet 12 and the extender 14, which would be extended to a tight end having the helmet 12 and the extender 14, which can then be extended to an offensive lineman having the helmet 12 and the extender 14. Any combination of players with the helmet 12 and the extender 14 can be used in the system 2.

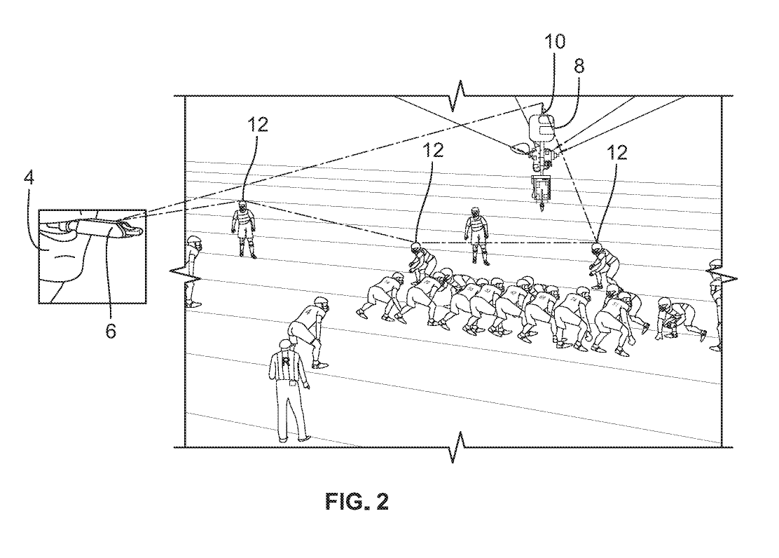

FIG. 2 is a diagram illustrating a second embodiment of a communication system between coaches and players of the present disclosure. In this embodiment, the coach 4 can speak commands in the first communications device 6 which can be broadcast as a wireless communication signal to be received by a plurality of helmets 12 and thus a plurality of players. It should be noted that this embodiment applies to other sports or activates, such as soccer, basketball, hockey, wrestling, lacrosse, track and field, racing, archery, darts, video gaming, curling, etc. The wireless communication signal can be extended by the camera 8 and the antenna extender 10 to the plurality of helmets 12 and players. Alternatively, the wireless communication signal can be extended by the camera 8 and the antenna extender 10 to at least one of the plurality of helmets 12 and then the at least one of the plurality of helmets 12 can extend the signal to another one of the plurality of helmets 12. This extension can occur multiple times to reach any number of helmets 12.

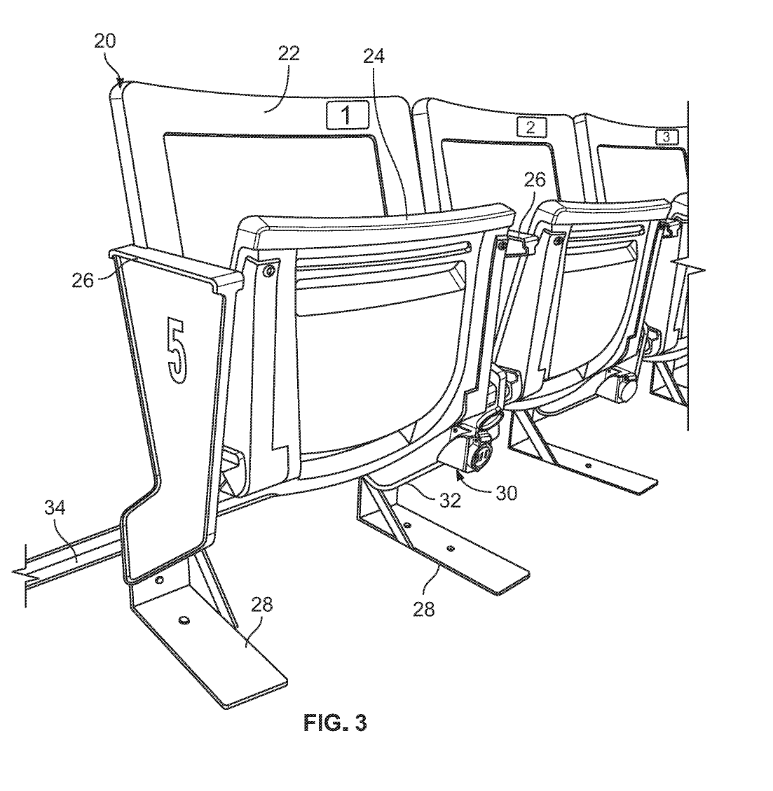

FIG. 3 is a diagram illustrating a power and wireless communications device installed at a seat in a venue. The venue can have a plurality of seats 20 for allowing fans to sit and watch a game or performance. The plurality of seats 20 can include a back portion 22 and a bottom portion 24. The back portion 22 allows a person or fan to rest their back and the bottom portion 24 allows a person to sit on the seat 20. The bottom portion 24 can fold upward toward the back portion 22 as shown in FIG. 3 to allow for easy ingress and egress through a row of the plurality of seats 20. The plurality of seats 20 can include an armrest 26 for allowing a fan to rest his/her arms. The plurality of seats 20 can be secured to the stadium via legs 28. The legs 28 can have a plurality of holes for securing the seat 20 to the stadium floor. Any means for securing the plurality of seats 20 can be used within the scope of the present disclosure.

A power and wireless communication device 30 can be secured to a bottom member 32 of the seat 20. A device 30 can be provided for each seat 20 in the venue/stadium. A metal conduit 34 can be located behind the plurality of seats 20 for attaching to a power switch which can provide power to the communication device 30. The power supplied by the conduit 34 can supply power to the communication device 30 when the venue is closed and can refrain from supplying power when the stadium is in operation allowing a battery pack of the communication device 30 to serve a fan or customer for a number of hours during or even after an event at the venue. The power supplied can be automatically turned on or off depending on whether the venue is open or closed. It should be noted that the communication device 30 does not have to be installed in the seat 20 and can be installed in another location suitable for providing cellular or wireless functionality to a fans mobile device as will be discussed in greater detail below.

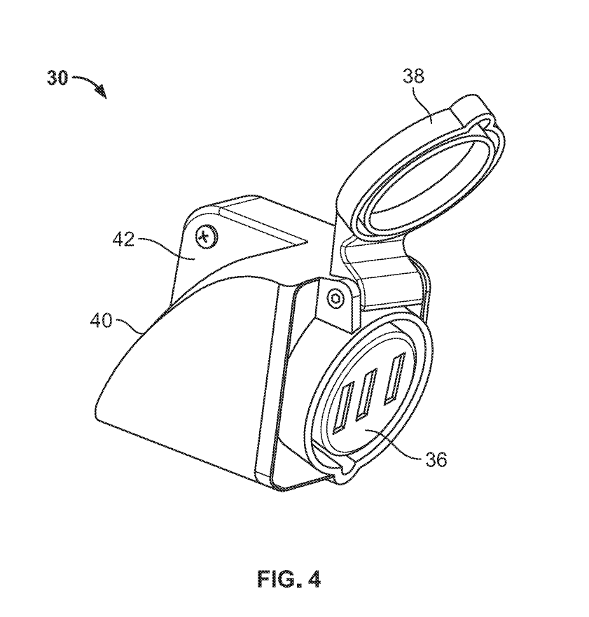

FIG. 4 is a perspective view of the wireless/cellular communication and/or tethered device 30 of the present disclosure. The communication device 30 can include a faceplate 36 for providing access to a rechargeable battery with USB-3, USB-C, Thunderbolt or similar connectivity means. The communication device 30 can also include a cap 38 having a spring snap function for closing over the faceplate 36. The cap 38 can be positionable in an open or closed position. The communication device 30 also includes a housing 40 and a back portion 42 for attaching the communication device 30 to the bottom member 32. The housing 40 can include electrical components such as a memory, processor, microcontroller, cache memory, and similar components for allowing the communication device 30 for accomplishing the objectives of the present disclosure as explained in detail herein. The communication device 30 can also include a seat sensor housing within the housing 40. The seat sensor can sense the weight of a person so the communication device can determine whether a person is sitting in the seat 20 or if someone is standing. The communication device 30 can upload data to a fan's mobile device, provide power to the mobile device, charge the mobile device, and capture mobile device information. The communication device 30 can match an electronic ticket on the fans mobile device with the seat number, making paper tickets obsolete. If a fan is in the wrong seat, the communication device 30 can send a notification on the fans mobile device to alert them to this fact. The communication device 30 can also alert security if there is an person who did not purchase a ticket. The communication device 30 can also transmit data to a central server. The central server can collect information for all the devices 30 in the stadium and can leverage such data for big data analytics. As will be explained in greater detail below, the communication device 30 also functions as a wireless/WIFI or cellular data provider for allowing fans to connect to the internet with their mobile devices. The communication device 30 can also be waterproof sealed and the electronic components in the housing 40 can be potted to prevent water damage from rain, snow, sleet, etc.

Importantly, as noted above, the device 30 includes circuitry for providing power to a user's cellular telephone (for powering and/or charging the cell phone), as well as wired and/or wireless connectivity for the telephone. For example, the device 30 could provide Internet connectivity for the telephone via the USB port (and a cable interconnecting the device 30 to the user's telephone) as well as any suitable wireless connection, such as WiFi, Bluetooth, etc. In this regard, the device 30 could include one or more of the power and wireless communications components and circuitry disclosed in published U.S. Patent Application Publication Nos. 2016/0313744, 2015/0244121, and 2014/0067137, the entire disclosures of which are expressly incorporated herein by reference.

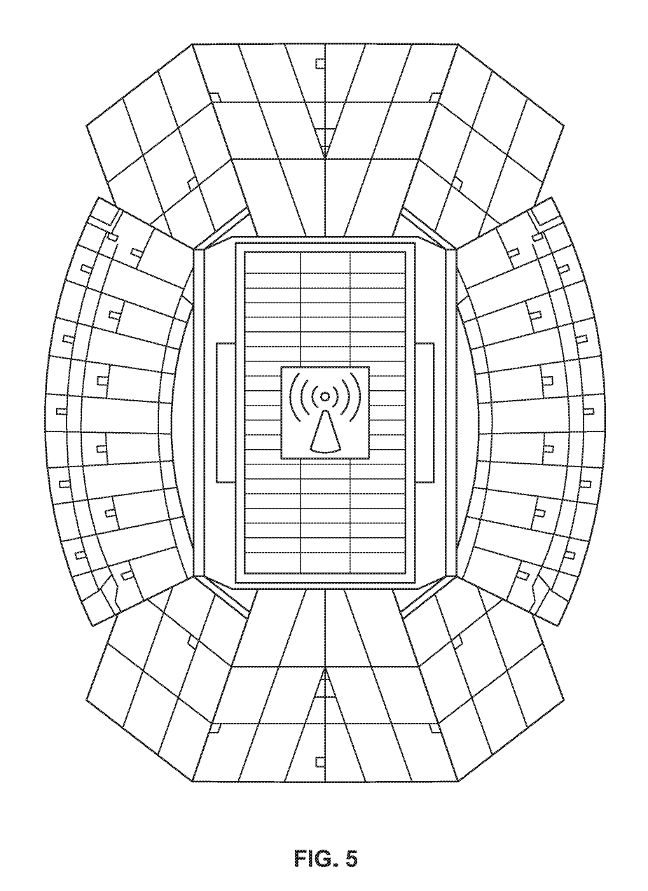

FIG. 5 is a top-down view of a venue with the wireless/cellular communication devices installed in the plurality of seats 20. As can be seen in FIG. 5, the ability of the communication device 30 to allow fans to connect to the Internet creates a connected network within the stadium or venue. This allows the venue to communicate and interact with the fans by displaying messages on a JUMBOTRON® and having the fans submit a text message to participate in a contest. The venue can also push marketing or promotional material to the fans.

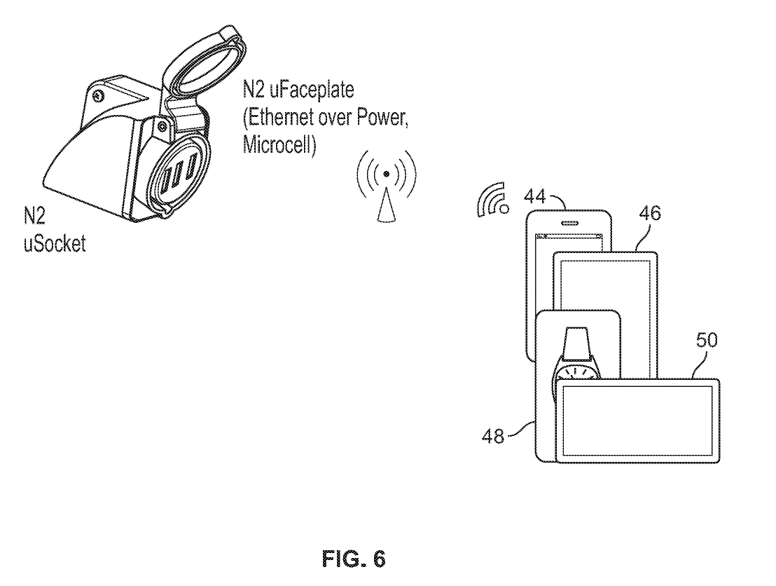

FIG. 6 is a block diagram of a communication link between the wireless/cellular communication device 30 and a plurality of mobile devices held by people in the venue. The plurality of mobile devices can include a smartphone 44, a tablet 46, a wearable device 48, or an information display 50.

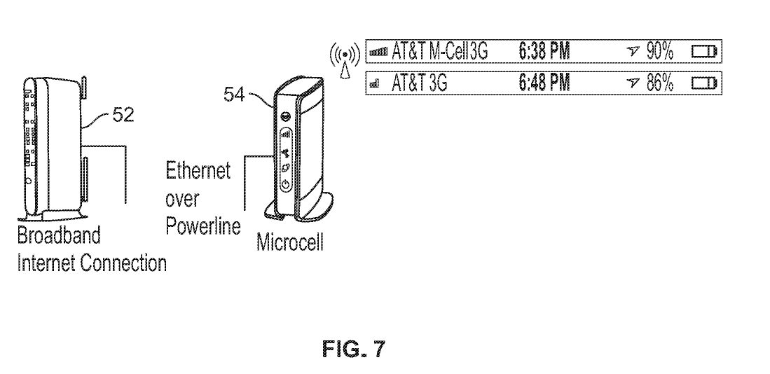

FIG. 7 is a diagram of a communication link to provide enhanced wireless/cellular coverage to people in the venue. A broadband internet connection 52 can be broadcast throughout the venue in a wireless or wired fashion, or Ethernet over powerline. A microcell 54 can be connected by Ethernet over powerline to the broadband internet connection 52 to provide cellular coverage where needed. It can connect to the cellular carrier networking using existing broadband internet service. Fans would receive improved cellular performance for both voice calls and cellular data applications.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A system for wireless communication at a venue, comprising:
a first communication device for receiving audio from a user of the first communication device, generating a wireless signal which includes the audio, and transmitting the wireless signal;
an antenna positioned on an overhead, cable-controlled camera for relaying the wireless signal; and
a second communication device for receiving the wireless signal and playing the audio to a user of the second communication device.

2. The system of claim 1, wherein a coach uses the first communication device.

3. The system of claim 1, wherein the second communication device is installed in a helmet.

4. The system of claim 3, wherein the helmet is worn by a quarterback.

5. The system of claim 1, wherein the antenna extends the wireless signal and broadcasts the wireless signal to a plurality of receivers.

6. A method for wireless communication, comprising:
receiving at a first communication device audio from a coach at a venue;
generating at the first communication device a wireless signal including the audio;
transmitting the wireless signal to an antenna system for relaying the wireless signal;
relaying the wireless signal to a second communication device worn by a player at the venue;
receiving the wireless signal at the second communication device; and
playing the audio to the player.

7. The method of claim 6, further comprising broadcasting the wireless signal to a plurality of receivers.

8. The method of claim 6, wherein the step of relaying the wireless signal comprises relaying the wireless signal to the second communication device using an antenna system mounted to an overhead camera at the venue.

9. A power and communications device for a seat at a venue, comprising:
a housing having electrical components for transmitting a cellular or wireless signal to a mobile device; and
a faceplate for receiving a connection cable for charging the mobile device,
wherein the device is installed proximal to a seat at a venue.

10. The device of claim 9, further comprising a cap positionable in an open or closed position over the faceplate.

11. The device of claim 9, wherein the device is connected to Ethernet over a powerline.

12. The device of claim 9, further comprising a sensor for sensing whether a person is sitting in the seat or standing.

13. The device of claim 9, wherein the device receives automatically receives electronic ticket information stored on the mobile device and determines whether a person is in the correct seat.

14. The device of claim 9, wherein the device can send promotional content to the mobile device.
